(19) United States
(12) Patent Application Publication
(10) Pub. No.: US 2014/0111056 A1
(43) Pub. Date: Apr. 24, 2014

(54) SMALL STEPPER MOTOR WITH MAXIMUM STATOR TEETH PER POLE

(71) Applicant: LIN ENGINEERING, Morgan Hill, CA (US)

(72) Inventors: Ted T. Lin, Saratoga, CA (US); Richard L. Badgerow, Watsonville, CA (US)

(73) Assignee: Lin Engineering, Morgan Hill, CA (US)

(21) Appl. No.: 13/863,570

(22) Filed: Apr. 16, 2013

Related U.S. Application Data
(60) Provisional application No. 61/717,544, filed on Oct. 23, 2012.

(51) Int. Cl. H02K 3/28

(52) U.S. Cl. CPC H02K 3/28
USPC 310/208

(57) ABSTRACT

A step motor having a stator constructed with six teeth per pole is achieved for a stator inner diameter (ID) less than one inch (25.4 mm) by a either (1) reducing the pitch angle of the outer teeth of each pole (e.g., to at most 6.8 degrees for a 19 mm stator ID), or (2) narrowing the tooth width of those outer teeth (e.g., to at most 0.0175 inch or 0.444 mm for a 19 mm stator ID), or (3) combination of both. These changes allow sufficient space (i.e., wider than 0.052 inch or 1.321 mm) between poles for passage of a winding needle, even with the extra stator teeth. Although narrowing the pitch angle and reducing the tooth width do sacrifice some torque contribution from each tooth, there still results a net overall gain in torque.

### CROSS-REFERENCE TO RELATED APPLICATION

This application claims priority under 35 U.S.C. 119(e) from prior U.S. provisional patent application number 61/717,544, filed Oct. 23, 2012.

### TECHNICAL FIELD

The present invention relates to electric stepper motors of small diameter and to improvements in stator design of such motors for increased torque.

### BACKGROUND ART

There have been many stator designs introduced in the motor industry to improve torque. For instance, conventional 1.8-degree steppers typically have 5 teeth per stator pole. Increasing to 6 teeth per pole would generally provide a gain of 20% in the torque. However, there is a limitation from the minimum space needed between the outer teeth of adjacent poles for passing a winding needle together with the insulated wire that it carries to form the electromagnetic coils around each stator pole. While a six-teeth per pole design exists for stator inner diameters larger than one inch (25.4 mm), as of today, the six-teeth per pole design has been constrained solely to such larger motors. It is desired that this limitation be overcome in order to improve torque in smaller motors. More generally, the goal is to maximize the number of teeth that can be fit onto each stator pole for a given size stepper motor.

### SUMMARY DISCLOSURE

A 1.8-degree step motor having a stator with a set of stator poles constructed with six teeth per pole is achieved for a stator inner diameter (ID) less than one inch (25.4 mm) by a either (1) reducing the pitch angle of the outer teeth of each pole (e.g., to at most 6.8 degrees for a 19 mm stator ID), or (2) narrowing the tooth width of those outer teeth (e.g., to at most 0.0175 inch or 0.444 mm for a 19 mm stator ID), or (3) combination of both. These changes allow sufficient space between poles for passage of a winding needle, even with the extra stator teeth. (For typical stator coil windings and associated winding needle, a space between the teeth of adjacent poles that is wider than about 0.052 inch or 1.321 mm is usually sufficient.) Although narrowing the pitch angle and reducing the tooth width do sacrifice some torque contribution from each tooth, there still results a net overall gain in torque.

A stepper motor in accord with the invention may be either a hybrid stepper or a variable reluctance motor. Such a stepper motor has a rotor with a plurality of rotor teeth, the rotor fitting within a stator winding assembly and seated by bearings on an axial shaft so as to rotate within the stator winding assembly. The stator winding assembly includes a stator with, e.g. 8, stator poles wound with coils that can be driven in a series of phases so as to magnetically interact with the rotor with a characteristic step angle, e.g. of 1.8°. The stator is characterized by an inner diameter (ID) of less than 1 inch (25.4 mm), each stator pole having 6 stator teeth adjacent to the rotor teeth with stator tooth pitch and stator tooth width being such that a gap between outermost teeth of adjacent stator poles is wider than 0.052 inch (1.321 mm). The stator tooth pitch may be at most 6.9 degrees and the stator tooth width may be at most 0.0185 inch (0.470 mm) for a 19 mm stator ID.

### BRIEF DESCRIPTION OF THE DRAWINGS

FIG. 1a is a plan view of a conventional 5-tooth per pole, 7.2-degree pitch angle stator design of the prior art.

FIG. 1b is a plan view of a 6-tooth per pole, 7.2-degree pitch angle stator design with conventional structure in accord with the prior art.

FIG. 1c is a plan view of a conventional 5-tooth per pole, 6.9-degree pitch angle stator design of the prior art.

FIG. 1d is a plan view of a 6-tooth per pole, 6.9-degree pitch angle stator design with conventional structure in accord with the prior art.

FIG. 2a is a plan view that shows a first embodiment of the present invention with a 6-tooth per pole, 6.9-degree pitch angle stator design characterized by a smaller pitch for the outer teeth of each pole.

FIG. 2b is a plan view that shows a second embodiment of the present invention with a 6-tooth per pole, 6.9-degree pitch angle stator design characterized by a narrower tooth width for the outer teeth.

FIG. 2c is a plan view that shows a third embodiment of the present invention with a 6-tooth per pole, 6.9-degree pitch angle stator design characterized by a combination of both slightly smaller tooth pitch and slightly narrower tooth width on the outer teeth.

### DETAILED DESCRIPTION

A stepper motor in accord with the invention has a rotor with a plurality of rotor teeth, the rotor fitting within a stator winding assembly and seated by bearings on an axial shaft so as to rotate within the stator winding assembly. The rotor may be of any conventional construction for step motors and is therefore not shown. The motor modifications for which the invention is characterized reside in the stator and in particular in the construction of the stator poles and their teeth.

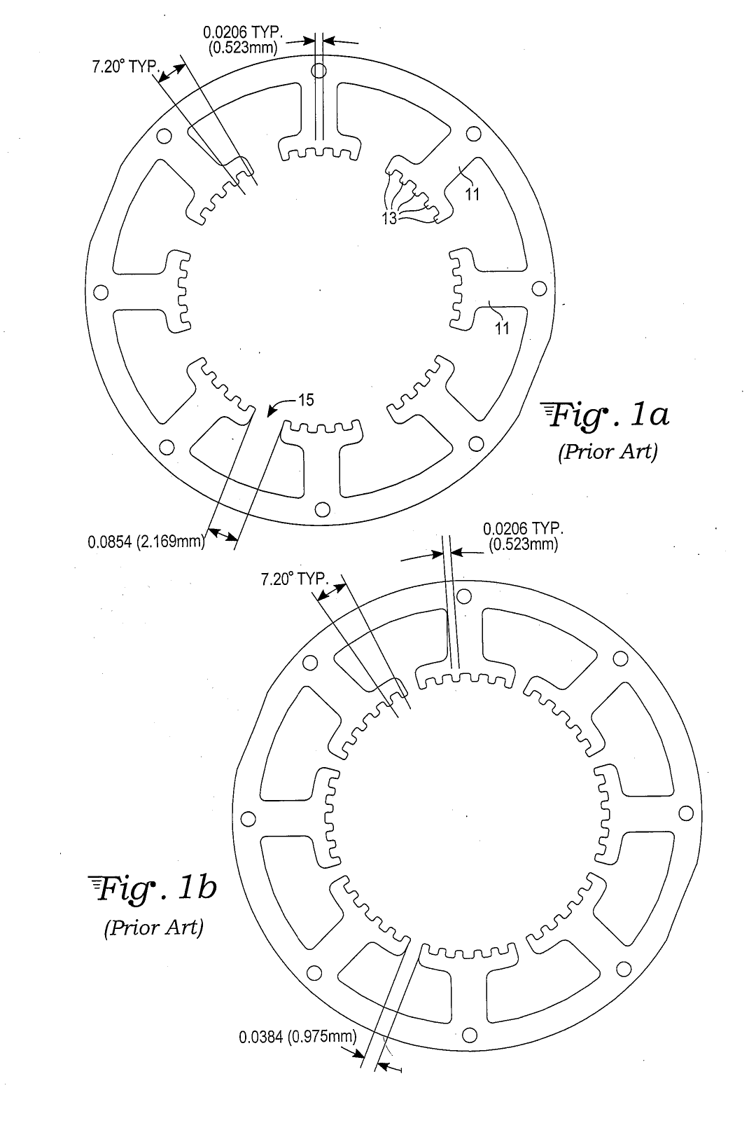

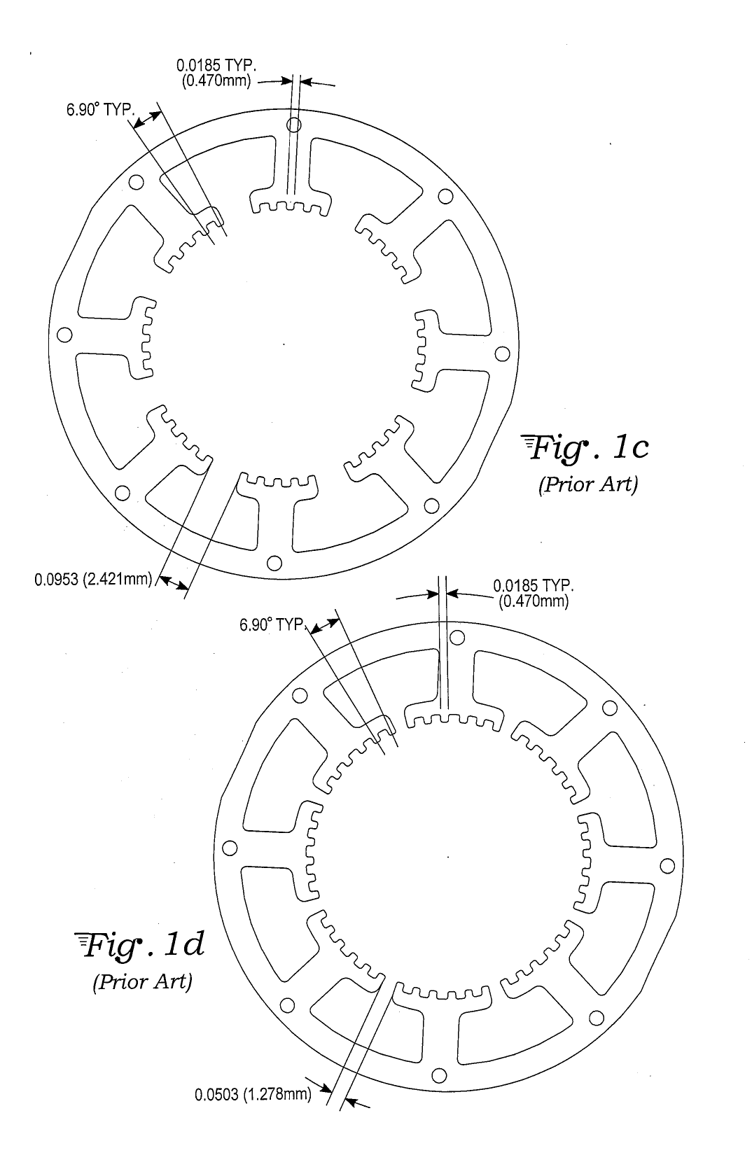

FIG. 1a shows a conventional 5-tooth per pole stator design of the prior art with a 7.2-degree pitch angle. With just five teeth 13 on each of the eight poles 11 and a typical tooth width of 0.0206 inch (0.523 mm), the space 15 between the outermost teeth of adjacent poles is 0.0854 inch (2.169 mm), which is sufficient for passage of a winding needle to thread the windings around the respective poles.

FIG. 1b shows what happens when the number of teeth per pole is increased from five to six, without further modification. A 6-tooth per pole, 7.2-degree pitch angle design with the conventional structure of the prior art can be used in larger motors (stator inner diameter larger than one inch (25.4 mm). However, based on a 19 mm stator ID, the gap between poles is now only 0.0384 inch (0.975 mm), which is too small for a winding needle (−0.052 inch or 1.321 mm) to pass. Accordingly, a 6-tooth per pole conventional stator structure cannot be used in the smaller motors.

FIGS. 1c and 1d show what happens when the overall pitch angle and width of the stator teeth is reduced. In FIG. 1c, a conventional 5-tooth per pole, 6.9-degree pitch angle design of the prior art with 0.0185 inch (0.470 mm) teeth provides a 0.0953 inch (2.421 mm) space for the winding needle for a 19 mm stator ID. FIG. 1d shows a 6-tooth per pole, 6.9-degree pitch angle design with a conventional structure in accord with the prior art. However, based on a 19 mm stator ID, the gap between poles is only 0.0503 inch (1.278 mm), which is still too small for a winding needle (−0.052 inch or 1:321 mm) to pass.

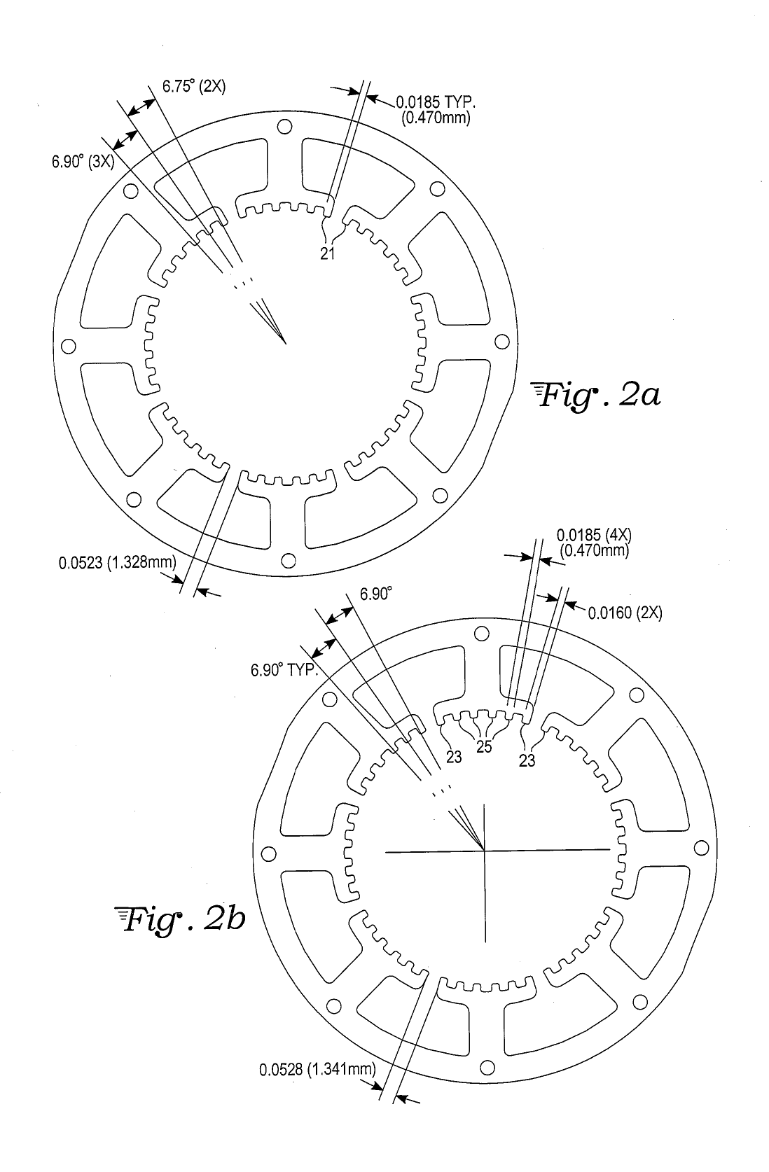

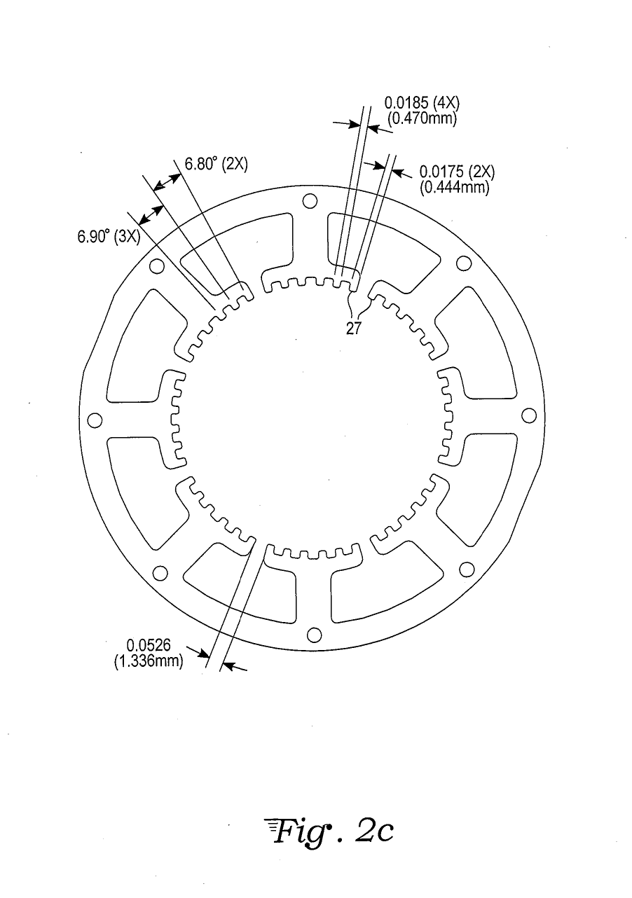

FIG. 2a shows a first embodiment of the present invention for a 6-tooth per pole, 6.9-degree pitch angle design with narrow pitch on the outer teeth 21. The outermost stator teeth on each pole have a pitch reduced to 6.75 degrees. Based on a 19 mm stator ID, the gap between poles is now 0.0523 inch (1.328 mm), which is sufficient for winding needle passage.

FIG. 2b shows a second embodiment of the invention for a 6-tooth per pole, 6.9-degree pitch angle design with narrow tooth width on the outer teeth 23. While the inner stator teeth 25 on each pole have a tooth width of 0.0185 inch (0.470 mm) as before, the outermost teeth 23 on each pole have a width reduced to 0.0160 inch (0.406 mm). Based on a 19 mm stator ID, the gap between poles is 0.0528 inch (1.341 mm), which is again sufficient for winding needle passage.

FIG. 2c shows a third embodiment of the invention for a 6-tooth per pole, 6.9-degree pitch angle design with both slightly smaller tooth pitch and slightly narrower tooth width on the outer teeth 27. Here, the outer pitch angle is reduced to 6.8 degrees and the outer tooth width is reduced to 0.0175 inch (0.444 mm). Based on a 19 mm stator ID, the gap between poles is 0.0526 inch (1.336 mm), which is again sufficient for winding pole passage.

The modifications to the stator design in the present invention allows use of six teeth per stator pole in order to potentially gain up to 20% more torque over conventional 5-teeth per pole stators. Reducing the pitch angle from 7.2-degree to 6.9-degree will lose about 10% of the torque, for a net total gain is 10%. We will use the example of a 19 mm stator inner diameter and a stator tooth width of 0.0185 inch (0.470 mm) for the following:

Then, for the first embodiment of FIG. 2a, reducing the tooth pitch to 6.75-degree on the two outer teeth will further reduce the torque by 2.9%. The net gain is about 7.1%.

For the second embodiment of FIG. 2b, narrowing the tooth width on the two outer teeth to 0.0160 inch (0.406 mm) will reduce the torque by 6.5%, for a net torque gain of about 3.5%.

For the third embodiment of FIG. 2c, combining both a slightly narrow tooth width (=0.0175 inch or 0.444 mm) and a slightly smaller pitch angle (=6.80 degrees) on the two outer teeth of each pole will lose about 2.9% of the torque. Thus, overall torque gain is 7.1% over a conventional 5-tooth per pole stator. Generally, this third embodiment will be preferred over the first two embodiments in the smallest motors.

The same basic changes to stator pole design (i.e., reducing stator tooth pitch and/or tooth width in the outermost teeth of each pole) can be used to accommodate extra stator teeth for other stator inner diameters (22 mm, etc.) while leaving enough space for the winding needle. An evaluation of the overall torque gain is required to justify the needed tooth pitch or width. reductions for the extra teeth in each particular design. However, in many cases a torque increase will be found so that the addition of extra stator teeth is desired.

What is claimed is:

1. A stepper motor, comprising:
a rotor with a plurality of rotor teeth, the rotor fitting within a stator winding assembly and seated by bearings on an axial shaft so as to rotate within the stator winding assembly,
the stator winding assembly including a stator with a set of stator poles wound with coils that can be driven in a series of phases so as to magnetically interact with the rotor with a characteristic step angle, the stator characterized by an inner diameter of less than 1 inch (25.4 mm), each stator pole having at least six stator teeth adjacent to the rotor teeth with stator tooth pitch and stator tooth width being such that a gap between outermost teeth of adjacent stator poles is wider than 0.052 inch (1.321 mm).

2. The stepper motor as in claim 1, wherein the characteristic step angle is 1.8°.

3. The stepper motor as in claim 2, wherein the inner diameter of the stator is 19 mm.

4. The stepper motor as in claim 3, wherein the number of stator poles is 8.

5. The stepper motor as in claim 4, wherein the stator tooth pitch is at most 6.9 degrees.

6. The stepper motor as in claim 4, wherein the outermost stator teeth in each pole have a stator tooth pitch of at most 6.8 degrees.

7. The stepper motor as in claim 4, wherein the stator tooth width is at most 0.0185 inch (0.470 mm).

8. The stepper motor as in claim 4, wherein the outermost stator teeth in each pole have a stator tooth width of at most 0.0175 inch (0.444 mm).

9. A 1.8-degree stepper motor, comprising:
a rotor with a plurality of rotor teeth, the rotor fitting within a stator winding assembly and seated by bearings on an axial shaft so as to rotate within the stator winding assembly,
the stator winding assembly including a stator with a 8 stator poles wound with coils that can be driven in a series of phases so as to magnetically interact with the rotor with a 1.8° step angle, the stator characterized by an inner diameter of less than 1 inch (25.4 mm), each stator pole having six stator teeth adjacent to the rotor teeth with stator tooth pitch and stator tooth width being such that a gap between outermost teeth of adjacent stator poles is wider than 0.052 inch (1.321 mm).

10. The stepper motor as in claim 9, wherein the stator tooth pitch is at most 6.9 degrees.

11. The stepper motor as in claim 9, wherein the outermost stator teeth in each pole have a stator tooth pitch of at most 6.8 degrees.

12. The stepper motor as in claim 9, wherein the stator tooth width is at most 0.0185 inch (0.470 mm).

13. The stepper motor as in claim 9, wherein the outermost stator teeth in each pole have a stator tooth width of at most 0.0175 inch (0.444 mm).
